(19) United States
(12) Patent Application Publication
(10) Pub. No.: US 2013/0100949 A1
(43) Pub. Date: Apr. 25, 2013

(54) DUAL PHYSICAL LAYER TRANSCEIVERS FOR HIGH SPEED SYNCHRONOUS INTERFACE (HSI) FRAME INTERLEAVING

(71) Applicants: Hans Georg Gruber, San Diego, CA (US); Philip M. Clovis, San Diego, CA (US)

(72) Inventors: Hans Georg Gruber, San Diego, CA (US); Philip M. Clovis, San Diego, CA (US)

(73) Assignee: QUALCOMM INCORPORATED, San Diego, CA (US)

(21) Appl. No.: 13/281,034

(22) Filed: Oct. 25, 2011

(51) Int. Cl. H04J 3/06

(52) U.S. Cl. 370/350

(57) ABSTRACT

An apparatus including dual physical layer transceivers for high speed synchronous interface (HSI) frame interleaving. The apparatus includes a first physical layer transceiver and a second physical layer transceiver. The apparatus further includes a frame interleaver that is communicably coupled to each of the first and second physical layer transceivers. The frame interleaver is operable to interleave a protocol data unit (PDU) of high speed synchronous interface (HSI) frames across uplink lanes of the first physical layer transceiver and uplink lanes of the second physical layer transceiver according to a pipe offset.

### BACKGROUND

1. Field

Aspects of the present disclosure relate generally to wireless communication systems, and more particularly to dual physical layer transceivers for high speed synchronous interface (HSI) frame interleaving.

2. Background

Wireless communication networks are widely deployed to provide various communication services such as voice, video, packet data, messaging, broadcast, etc. These wireless networks may be multiple-access networks capable of supporting multiple users by sharing the available network resources. A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

According to one aspect of the present disclosure, an apparatus including dual physical layer transceivers for high speed synchronous interface (HSI) frame interleaving is described. The apparatus includes a first physical layer transceiver and a second physical layer transceiver. The apparatus further includes a frame interleaver that is communicably coupled to each of the first and second physical layer transceivers. In this aspect of the present disclosure, the frame interleaver is operable to interleave a protocol data unit (PDU) of high speed synchronous interface (HSI) frames across uplink lanes of the first physical layer transceiver and uplink lanes of the second physical layer transceiver according to a pipe timing offset.

According to one aspect of the present disclosure, a method for high speed synchronous interface (HSI) frame interleaving using dual physical layer transceivers is described. The method includes interleaving a protocol data unit (PDU) of high speed synchronous interface (HSI) frames across uplink lanes of a first physical layer transceiver and uplink lanes of the second physical layer transceiver according to a pipe timing offset.

In another aspect, an apparatus for high speed synchronous interface (HSI) frame interleaving using dual physical layer transceivers is described. The apparatus includes at least one processor; and a memory coupled to the at least one processor. The processor(s) is configured to interleave a protocol data unit (PDU) of high speed synchronous interface (HSI) frames across uplink lanes of a first physical layer transceiver and uplink lanes of a second physical layer transceiver according to a pipe timing offset.

In a further aspect, a computer program product for high speed synchronous interface (HSI) frame interleaving using dual physical layer transceivers is described. The computer program product includes a non-transitory computer-readable medium having program code recorded thereon. The computer program product has program code to interleave a protocol data unit (PDU) of high speed synchronous interface (HSI) frames across uplink lanes of a first physical layer transceiver and uplink lanes of a second physical layer transceiver according to a pipe timing offset.

In another aspect, an apparatus for high speed synchronous interface (HSI) frame interleaving using dual physical layer transceivers is described. The apparatus includes means for receiving a protocol data unit (PDU) of high speed synchronous interface (HSI) frames. The apparatus also includes means for interleaving the PDU of HSI frames across uplink lanes of a first physical layer transceiver and uplink lanes of a second physical layer transceiver according to a pipe timing offset.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a diagram conceptually illustrating an example of a downlink frame structure in a telecommunications system.

FIG. 3 is a block diagram conceptually illustrating an example frame structure in uplink communications.

FIG. 4 is a block diagram conceptually illustrating a design of a base station/eNodeB and a UE configured according to one aspect of the present disclosure.

FIG. 5 is a block diagram illustrating a user equipment (UE) interface including dual physical layer transceivers for high speed synchronous interface (HSI) frame interleaving, according to one aspect of the present disclosure.

FIG. 6 is a block diagram further illustrating the UE interface of FIG. 5 including dual physical layer transceivers according to a further aspect of the present disclosure.

FIGS. 7A and 7B are diagrams illustrating the interleaving of a protocol data unit (PDU) of frames according to one aspect of the present disclosure.

FIG. 8 is a block diagram illustrating a processor/modem interface including dual physical layer transceivers for high speed synchronous interface (HSI) frame interleaving, according to one aspect of the present disclosure.

FIG. 9 is a block diagram illustrating a method for high speed synchronous interface (HSI) frame interleaving, according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA) and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like.

The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. For clarity, certain aspects of the techniques are described below for LTE or LTE-A (together referred to in the alternative as “LTE/-A”) and use such LTE/-A terminology in much of the description below.

Release eight (Release-8) of the long term evolution (LTE) standard includes five user equipment (UE) categories. Release-8 of the LTE standard will soon require UE interfaces to support the category five (5) release of the UE categories. The category 5 release specifies a peak downlink rate of three hundred and nine (309) megabits per second (Mbps) and a peak uplink rate of seventy-five (75) Mbps. A current UE interface solution is generally not available to fulfill the category 5 release peak uplink and downlink rates. A mobile industry solution, such as the Mobile Industry Processor Interface (MIPI) Alliance, for meeting the category 5 peak data rate requirements will undergo many standard cycles before being adopted by the mobile industry. According to one aspect of the present disclosure, a dual physical layer transceiver for high speed synchronous interface (HSI) frame interleaving provides a modem solution for meeting the category 5 peak data rate (bandwidth) requirement.

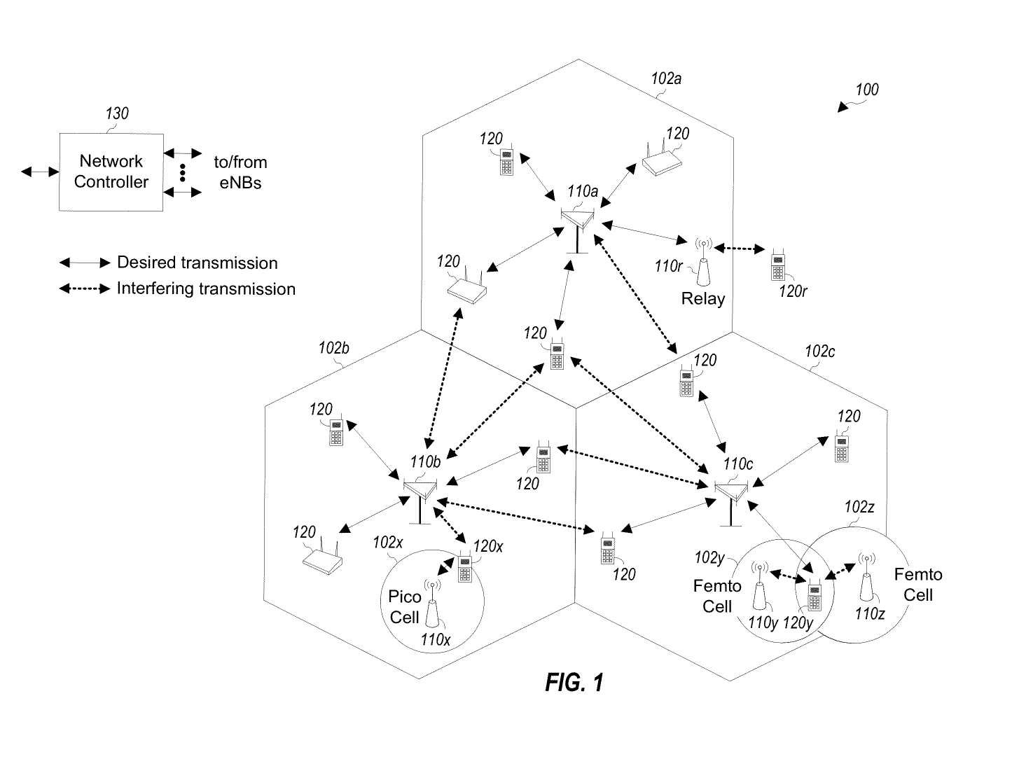

FIG. 1 shows a wireless communication network 100, which may be an LTE-A network, in which dual physical layer transceivers for high speed synchronous interface (HSI) frame interleaving may be implemented. The wireless network 100 includes a number of evolved node Bs (eNodeBs) 110 and other network entities. An eNodeB may be a station that communicates with the UEs and may also be referred to as a base station, a node B, an access point, and the like. Each eNodeB 110 may provide communication coverage for a particular geographic area. In 3GPP, the term “cell” can refer to this particular geographic coverage area of an eNodeB and/or an eNodeB subsystem serving the coverage area, depending on the context in which the term is used.

An eNodeB may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNodeB for a macro cell may be referred to as a macro eNodeB. An eNodeB for a pico cell may be referred to as a pico eNodeB. And, an eNodeB for a femto cell may be referred to as a femto eNodeB or a home eNodeB. In the example shown in FIG. 1, the eNodeBs 110a, 110b and 110c are macro eNodeBs for the macro cells 102a, 102b and 102c, respectively. The eNodeB 110x is a pico eNodeB for a pico cell 102x. And, the eNodeBs 110y and 110z are femto eNodeBs for the femto cells 102y and 102z, respectively. An eNodeB may support one or multiple (e.g., two, three, four, and the like) cells.

The wireless network 100 may also include relay stations. A relay station is a station that receives a transmission of data and/or other information from an upstream station (e.g., an eNodeB, UE, etc.) and sends a transmission of the data and/or other information to a downstream station (e.g., a UE or an eNodeB). A relay station may also be a UE that relays transmissions for other UEs. In the example shown in FIG. 1, a relay station 110r may communicate with the eNodeB 110a and a UE 120r in order to facilitate communication between the eNodeB 110a and the UE 120r. A relay station may also be referred to as a relay eNodeB, a relay, etc.

The wireless network 100 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network 100. For example, macro eNodeBs may have a high transmit power level (e.g., 20 Watts) whereas pico eNodeBs, femto eNodeBs and relays may have a lower transmit power level (e.g., 1 Watt).

The wireless network 100 may support synchronous or asynchronous operation. For synchronous operation, the eNodeBs may have similar frame timing, and transmissions from different eNodeBs may be approximately aligned in time. For asynchronous operation, the eNodeBs may have different frame timing, and transmissions from different eNodeBs may not be aligned in time. The techniques described herein may be used for either synchronous or asynchronous operations.

In one aspect, the wireless network 100 may support Frequency Division Duplex (FDD) or Time Division Duplex (TDD) modes of operation. The techniques described herein may be used for either FDD or TDD mode of operation.

A network controller 130 may couple to a set of eNodeBs 110 and provide coordination and control for these eNodeBs 110. The network controller 130 may communicate with the eNodeBs 110 via a backhaul. The eNodeBs 110 may also communicate with one another, e.g., directly or indirectly via a wireless backhaul or a wireline backhaul.

The UEs 120 with dual physical layer transceivers are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a laptop computer, a cordless phone, a wireless local loop (WLL) station, a tablet, or the like. A UE may be able to communicate with macro eNodeBs, pico eNodeBs, femto eNodeBs, relays, and the like. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for a corresponding system bandwidth of 1.25, 2.5, 5, 10 or 20 megahertz (MHz), respectively. The system bandwidth may also be partitioned into sub-bands. For example, a sub-band may cover 1.08 MHz (i.e., 6 resource blocks), and there may be 1, 2, 4, 8 or 16 sub-bands for a corresponding system bandwidth of 1.25, 2.5, 5, 10, 15 or 20 MHz, respectively.

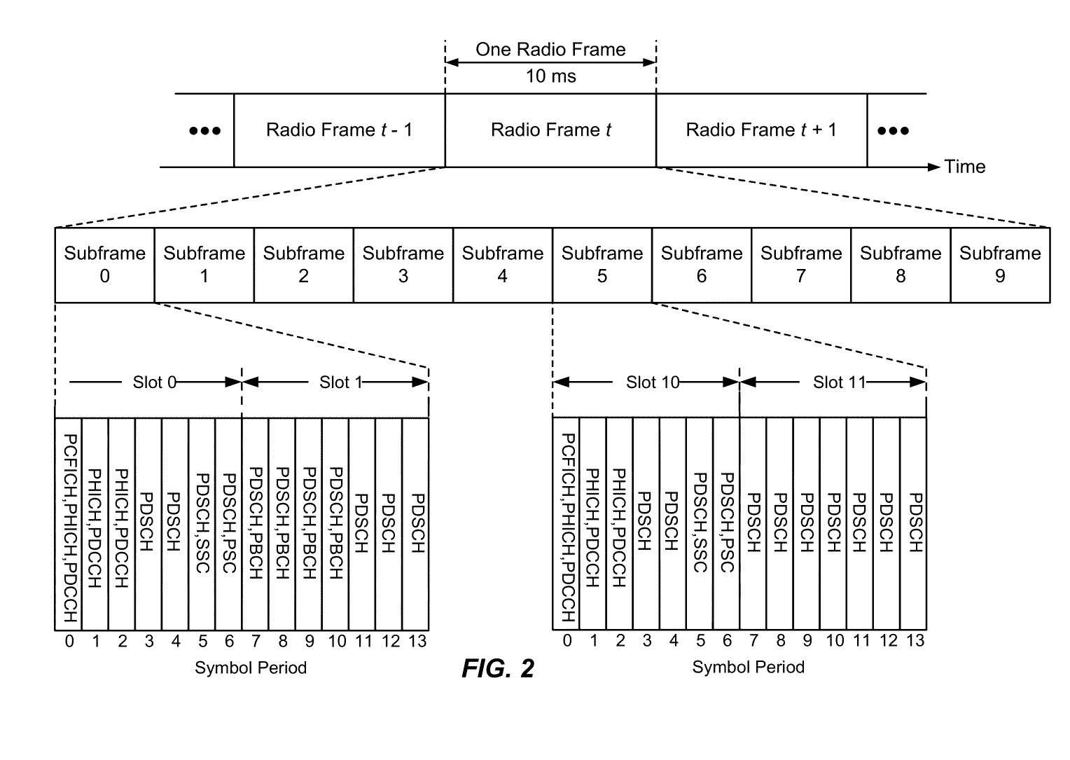

FIG. 2 shows a downlink FDD frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNodeB may send a primary synchronization signal (PSC or PSS) and a secondary synchronization signal (SSC or SSS) for each cell in the eNodeB. For FDD mode of operation, the primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. For FDD mode of operation, the eNodeB may send a Physical Broadcast Channel (PBCH) in symbol periods 0 to 3 in slot 1 of subframe 0. The PBCH may carry certain system information.

The eNodeB may send a Physical Control Format Indicator Channel (PCFICH) in the first symbol period of each subframe, as seen in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNodeB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 2. The PHICH may carry information to support hybrid automatic repeat request (HARQ) retransmission. The PDCCH may carry information on uplink and downlink resource allocation for UEs and power control information for uplink channels. The eNodeB may send a Physical Downlink Shared Channel (PDSCH) in the remaining symbol periods of each subframe. The PDSCH may carry data for UEs scheduled for data transmission on the downlink.

The eNodeB may send the PSC, SSC and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to groups of UEs in specific portions of the system bandwidth. The eNodeB may send the PSC, SSC, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. For symbols that are used for control channels, the resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 36 or 72 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for all UEs in the PDCCH. An eNodeB may send the PDCCH to the UE in any of the combinations that the UE will search.

A UE may be within the coverage of multiple eNodeBs. One of these eNodeBs may be selected to serve the UE. The serving eNodeB may be selected based on various criteria such as received power, path loss, signal-to-noise ratio (SNR), etc.

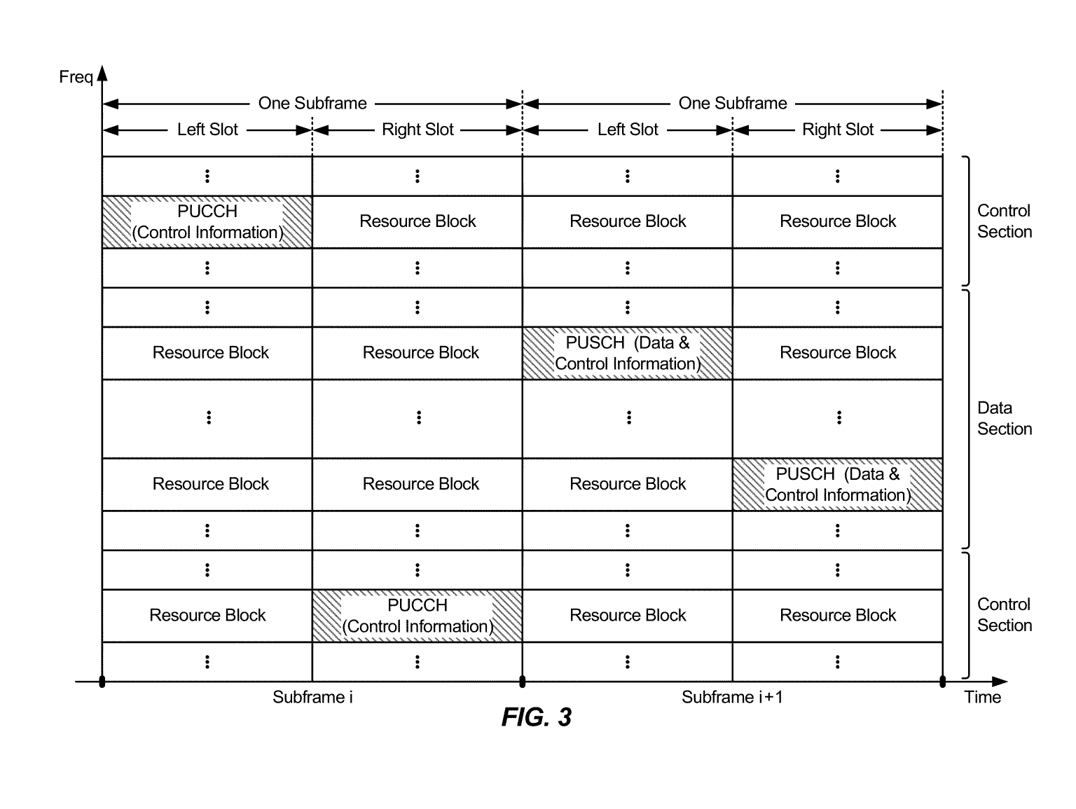

FIG. 3 is a block diagram conceptually illustrating an exemplary FDD and TDD (non-special subframe only) subframe structure in uplink long term evolution (LTE) communications. The available resource blocks (RBs) for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 3 results in the data section including contiguous subcarriers, which may allow a single UE to be assigned all of the contiguous subcarriers in the data section.

A UE may be assigned resource blocks in the control section to transmit control information to an eNodeB. The UE may also be assigned resource blocks in the data section to transmit data to the eNode B. The UE may transmit control information in a Physical Uplink Control Channel (PUCCH) on the assigned resource blocks in the control section. The UE may transmit only data or both data and control information in a Physical Uplink Shared Channel (PUSCH) on the assigned resource blocks in the data section. An uplink transmission may span both slots of a subframe and may hop across frequency as shown in FIG. 3. According to one aspect, in relaxed single carrier operation, parallel channels may be transmitted on the UL resources. For example, a control and a data channel, parallel control channels, and parallel data channels may be transmitted by a UE.

The PSC (primary synchronization carrier), SSC (secondary synchronization carrier), CRS (common reference signal), PBCH, PUCCH, PUSCH, and other such signals and channels used in LTE/-A are described in 3GPP TS 36.211, entitled “Evolved Universal Terrestrial Radio Access (E-UTRA); Physical Channels and Modulation,” which is publicly available.

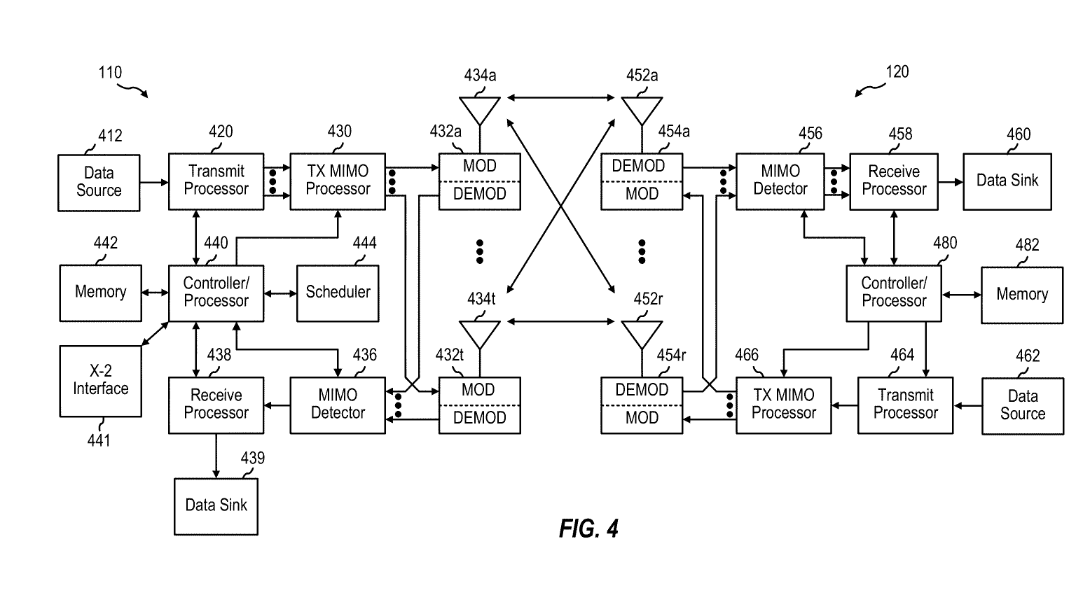

FIG. 4 shows a block diagram of a design of a base station/eNodeB 110 and a UE 120, which may be one of the base stations/eNodeBs and one of the dual physical; layer transceiver UEs in FIG. 1. The base station 110 may be the macro eNodeB 110c in FIG. 1, and the UE 120 may be the UE 120y. The base station 110 may also be a base station of some other type. The base station 110 may be equipped with antennas 434a through 434t, and the UE 120 may be equipped with antennas 452a through 452r.

At the base station 110, a transmit processor 420 may receive data from a data source 412 and control information from a controller/processor 440. The control information may be for the PBCH, PCFICH, PHICH, PDCCH, etc. The data may be for the PDSCH, etc. The processor 420 may process (e.g., encode and symbol map) the data and control information to obtain data symbols and control symbols, respectively. The processor 420 may also generate reference symbols, e.g., for the PSS, SSS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at the UE 120, a transmit processor 464 may receive and process data (e.g., for the PUSCH) from a data source 462 and control information (e.g., for the PUCCH) from the controller/processor 480. The processor 464 may also generate reference symbols for a reference signal. The symbols from the transmit processor 464 may be precoded by a TX MIMO processor 466 if applicable, further processed by the modulators 454a through 454r (e.g., for SC-FDM, etc.), and transmitted to the base station 110. At the base station 110, the uplink signals from the UE 120 may be received by the antennas 434, processed by the demodulators 432, detected by a MIMO detector 436 if applicable, and further processed by a receive processor 438 to obtain decoded data and control information sent by the UE 120. The processor 438 may provide the decoded data to a data sink 439 and the decoded control information to the controller/processor 440. The base station 110 can send messages to other base stations, for example, over an X2 interface 441.

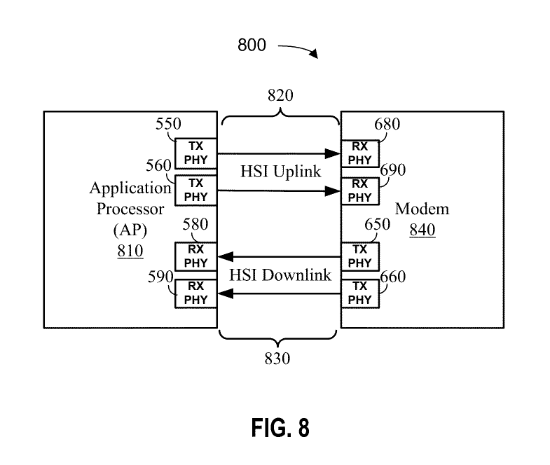

The controllers/processors 440 and 480 may direct the operation at the base station 110 and the UE 120, respectively. The processor 440 and/or other processors and modules at the base station 110 may perform or direct the execution of various processes for the techniques described herein. The processor 480 and/or other processors and modules at the UE 120 may also perform or direct the execution of the functional blocks illustrated in use method flow chart FIG. 8, and/or other processes for the techniques described herein. The memories 442 and 482 may store data and program codes for the base station 110 and the UE 120, respectively. A scheduler 444 may schedule UEs for data transmission on the downlink and/or uplink.

### Dual Physical Layer Transceiver HSI Frame Interleaving

Release eight (Release-8) of the long term evolution (LTE) standard includes five user equipment (UE) categories. Release-8 of the LTE standard will soon require UE interfaces (e.g., an application processor to modem interface) to support the category five (5) release of the UE categories. The category 5 release specifies a peak downlink rate of three hundred and nine (309) megabits per second (Mbps) and a peak uplink rate of seventy-five (75) Mbps. Current UE interface solutions are generally not available to fulfill the category 5 release peak uplink and downlink rates. A mobile industry solution, such as the Mobile Industry Processor Interface (MIPI) Alliance, for meeting the category 5 peak data rate requirements will undergo many standard cycles before being adopted by the mobile industry.

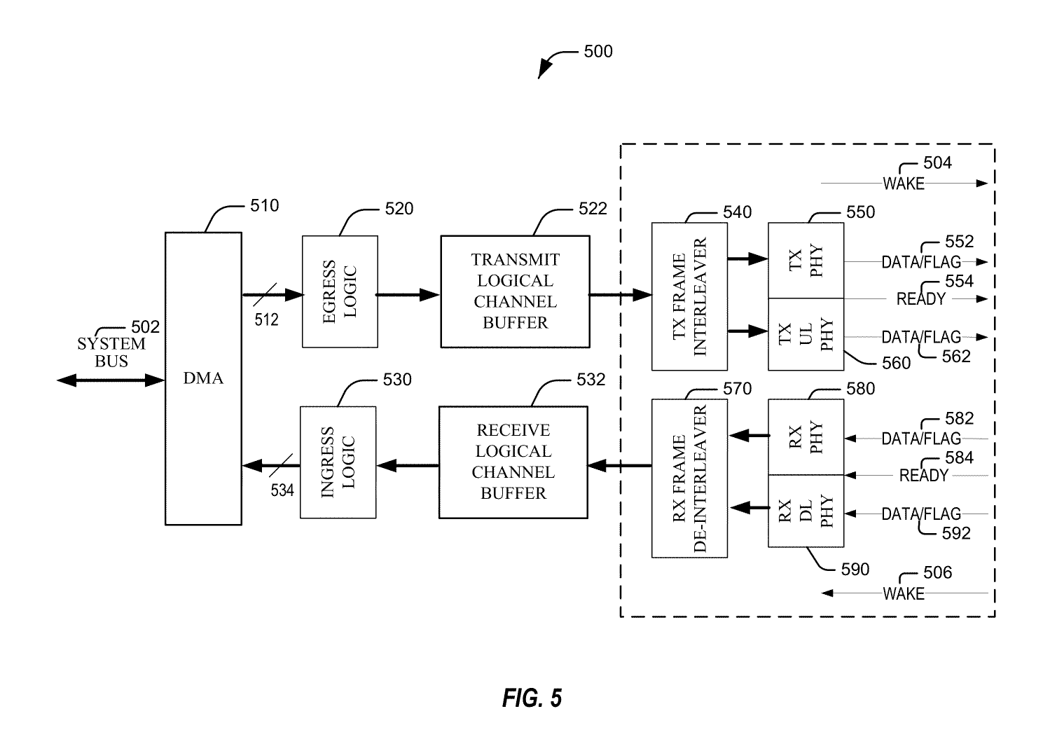

In one aspect of the present disclosure, a dual physical layer transceiver for high speed synchronous interface (HSI) frame interleaving may provide a processor/modem interface solution for meeting the category 5 peak data rate (bandwidth) requirement. FIG. 5 is a block diagram illustrating a UE interface 500 including dual physical layer transceivers for high speed synchronous interface (HSI) frame interleaving, according to one aspect of the present disclosure. A physical layer of a conventional UE interface may operate according to an existing MIPI specification, such as a legacy High Speed Synchronous Interface (HSI). A conventional HSI link may operate at a peak data rate of two-hundred (200) Mbps for single direction throughput. In one configuration, the UE interface 500 includes duplicate physical layers for meeting the category 5 peak data rate requirements.

FIG. 5 illustrates a UE interface 500 including dual physical layer transceivers according to one aspect of the present disclosure. Representatively, the UE interface 500 may include a first physical layer transceiver 550/580 and a second physical layer transceiver 560/590 to enable, for example, a peak uplink or downlink data rate of four-hundred (400) Mbps for single direction throughput. In one aspect, the physical layer transceivers 550/580 and 560/590 support independent usage of the UE interface 500 to provide the specified throughput and bandwidth for supporting category 5 of LTE Release-8. In one configuration, a new gasket (e.g., interleaver; striper) 540/570 bonds the downlink (e.g., first physical layer transceiver 550/580) and the downlink/uplink lanes (e.g., second physical layer transceiver 560/590) to support data transportation to an existing System on Chip (SoC) infrastructure (not shown).

Representatively, the UE interface 500 shown in FIG. 5 further includes direct memory access (DMA) logic 510 for reading/writing to, for example, a system memory (not shown). Uplink data 512 may be provided to egress logic 520 and downlink data 534 may be received from ingress logic 530. In one configuration, the uplink data 512 is stored in a transmit logical channel buffer 522 and the downlink data 534 is retrieved from a receive logical channel buffer 532. In one configuration, the buffers 522/532 may operate according to a first in first out (FIFO) configuration. The uplink data 512 is provided from the transmit logical channel buffer 522 to a transmit frame interleaver 540. Similarly, the downlink data 534 is provided to the receive logical channel buffer 532 from a receive frame interleaver 570.

As shown in FIG. 5, the dual transmitters 550 and 560 may operate according to a wake signal 504, a data/flag signal 552/562 and a shared ready signal 554, which is shared among the dual transmitters 550 and 560. Similarly, the dual receivers 580 and 590 may operate according to a wake signal 506, data/flag signals 582/592 and a shared ready signal 584, which is shared among the dual receivers 580 and 590. In one configuration, the first physical layer transceiver 550/580 is dedicated as a downlink physical layer transceiver, and the second physical layer transceiver 560/590 is specified as a downlink/uplink transceiver.

In one aspect, the first and second physical layer transceiver 550/580 and 560/590 include a gasket/interleaver (e.g., transmit/receive interleaver 540/570) to “stripe” data across the transmit and receive lanes of the transceivers. The ability to “stripe” data across the transmit and the receive lanes of the first and second physical layer transceivers 550/580 and 560/590 allows reuse of an existing high speed synchronous interface (HSI) infrastructure developed for a single HSI interface. In a further configuration, a duplication of the infrastructure can be considered to enable different use cases.

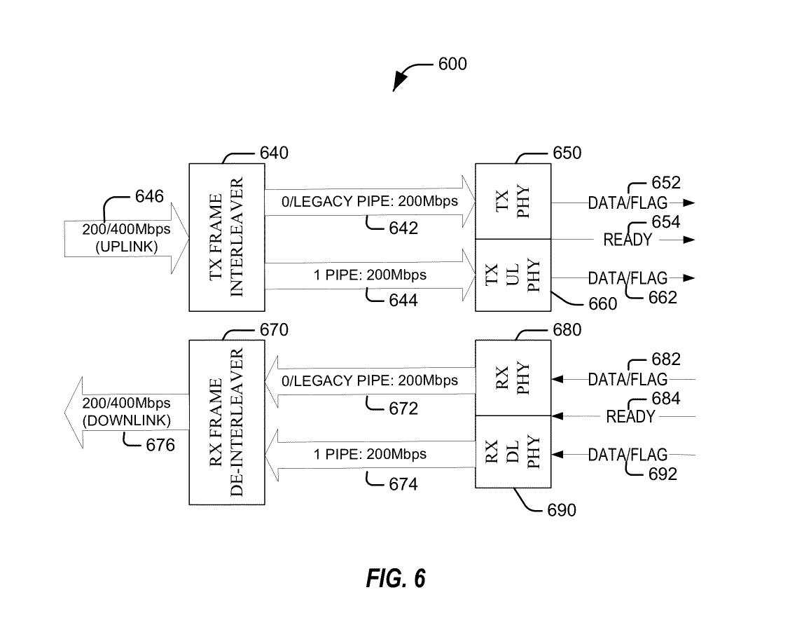

FIG. 6 is a diagram 600 further illustrating the UE interface 500 including dual physical layer transceivers according to one aspect of the present disclosure. Representatively, uplink data 646 is received at the transmit frame interleaver 640. In this configuration, the UE interface includes a first physical layer transceiver 650/680 and a second physical layer transceiver 660/690 to enable, for example, a peak uplink or downlink data rate of four-hundred (400) Mbps. In one aspect, a bandwidth of a legacy pipe 642 is doubled by the inclusion of a pipe 644 using the dual transmitters 650 and 660. The dual transmitters operate according to individual data/flag signals 652/662 and a shared ready signal 654. In this configuration, the legacy pipe 642 supports up to the category four (4) release of the UE categories, which specifies a peak downlink rate of one hundred fifty (150) Mbps and a peak uplink rate of fifty (50) Mbps.

As further illustrated in FIG. 6, downlink data 676 is received at the receive frame de-interleaver 670. In this configuration, a bandwidth of the legacy pipe 672 is doubled by the inclusion of a pipe 674 using the dual receivers 680 and 690, which operate according to a data/flag signal 682/692 and a shared ready signal 684. The legacy pipe 672 operates according to the peak downlink rate of two hundred (200) Mbps. In this configuration, the inclusion of the pipe 674 enable a maximum data rate of 400 Mbps, in excess of the category 5 release peak downlink rate of 309 Mbps.

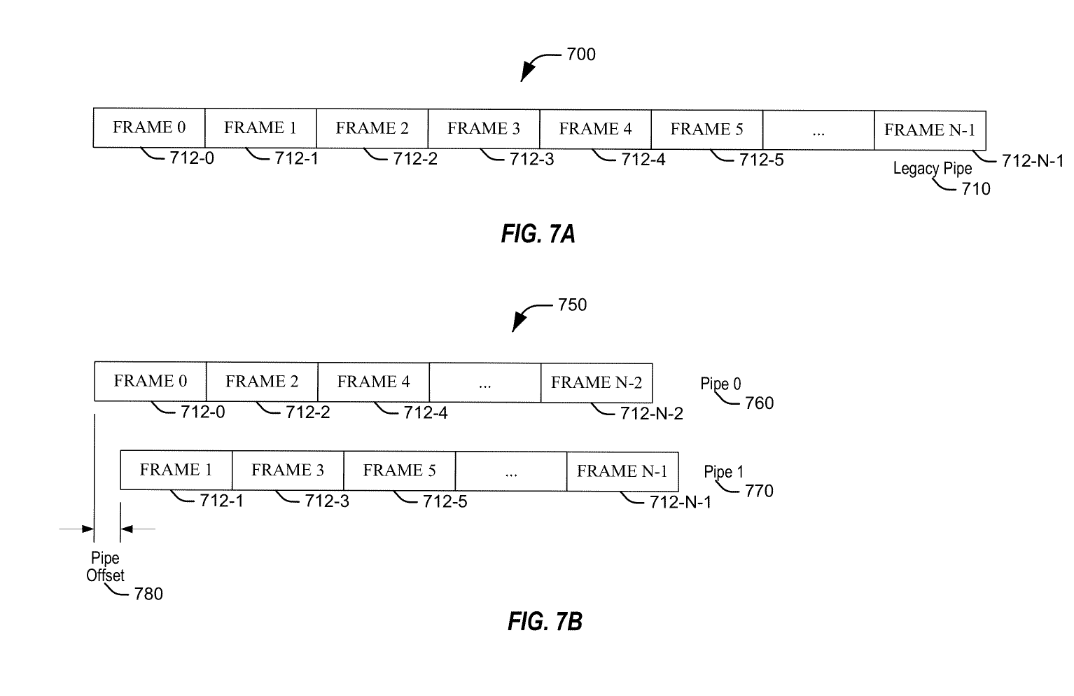

In one aspect, the transmit frame interleaver 640 interleaves a protocol data unit (PDU) of high speed synchronous interface (HSI) frames across uplink lanes of the first physical layer transceiver 650/680 and uplink lanes of a second physical layer transceiver 660/690 according to a pipe offset. As described herein, frame interleaving may refer to the channeling (distribution) of frames across the uplink lanes of at least two physical layer transceiver for increasing an uplink data rate, for example, as shown in FIGS. 7A and 7B. In a further aspect, interleaving of data frames may be performed as received from a dedicated FIFO (even/odd) arrangement (e.g., a transmit logical channel buffer 522 (FIG. 5)) and/or by frame striping (e.g., frame multiplexing) across the uplink and downlink lanes of the dual physical layer transceivers 650/680 and 660/690 to ensure that the frames ordered correctly for transmission/reception across dual transceivers.

In a further aspect, the receive frame de-interleaver 670 receives HSI frames on the downlink lanes of the first physical layer transceiver 650/680 and downlink lanes of the second physical layer transceiver 660/690. In this configuration, the receive frame de-interleaver 670 is operable to de-interleave the received HSI frames according to a pipe offset. As described herein, frame de-interleaving may refer to the reordering of interleaved frames into an original, sequential frame order. Interleaving/de-interleaving of HSI frames is further illustrated in FIGS. 7A and 7B.

FIG. 7A is a diagram 700 illustrating a protocol data unit (PDU) of N-frames 712 (712-0, . . . , 712-N−1) as transmitted/received over a legacy pipe 710. In one aspect, the PDU of N-frames 712 may be interleaved over pipe-0 760 and pipe-1 770, as shown in FIG. 7B. The interleaving may be performed using the transmit frame interleaver 540 (FIG. 5) or the transmit frame interleaver 640 (FIG. 6).

FIG. 7B is a diagram illustrating an interleaving of frames 750 according to one aspect of the present disclosure. Representatively, even frames (e.g., 712-0, 712-2, 712-4, . . . , 712-N−2) are transmitted over pipe-0 760. Similarly, odd frames (e.g., 712-1, 712-3, 712-5, . . . , 712-N−1) are transmitted over pipe-1 770. In this configuration, the odd and even frames are separated by a pipe offset 780.

In a further configuration, the pipe offset 780 indicates the pipe (760/780) in which the first frame is transmitted/received. In one aspect, a de-interleaver (e.g., receive frame de-interleaver 670) receives the interleaved frames 750, over pipe-0 760 and pipe-1 770, separated according to the pipe offset 780. Based on the pipe offset 780, the de-interleaver can return the interleaved frames 750 into the original order shown in FIG. 7A by determining the pipe (e.g., pipe-0 760/pipe-1 770) in which the first frame is received.

FIG. 8 is a block diagram illustrating a processor/modem interface 800 including dual physical layer transceivers for high speed synchronous interface (HSI) frame interleaving, according to one aspect of the present disclosure. Representatively, the processor/modem interface 800 includes an application processor 810 and a modem 840, communicably couple according to a link protocol (e.g., a high speed synchronous interface (HSI) link protocol). In this aspect of the present disclosure, the application processor includes dual transmitters 550/560 for transmitting data over an HSI uplink 820 to the dual receivers 680/690 of the modem 840. As further shown in FIG. 8, the modem 840 includes dual transmitters 650/660 for transmitting data over an HSI downlink 830 to the dual receivers 580/590 of the application processor 810.

As shown in FIG. 8, a transceiver 550/580 of the application processor 810 may represent a baseline (legacy) transceiver mode, which supports full-duplex aggregated throughput of 400 Mbps (e.g., 200 Mbps for each of uplink/downlink). In one aspect of the present disclosure, the transceiver 560/590 is enabled with the frame interleaver logic 540/570 (FIG. 5) to provide 800 Mbps of aggregated throughput. Depending on the deployment configuration (e.g., modem vs. application processor), the transmitter 560 and receiver 690 may be omitted, while still meeting the category 5 uplink peak data rate requirement. In a modem deployment configuration of the present disclosure, the transmitter 650 and the transmitter 660 are used as the modem transmits downlink data to the application processor 810. In an application processor deployment configuration of the present disclosure, the receiver 590 and the receiver 580 are used as the application processor 810 receives downlink data from the modem 840 at a peak data rate of 400 Mbps.

In one aspect of the present disclosure, a different method of using the lane capability of the existing HSI-specification for each of the physical layer transceivers 550/580/560/590 and 650/580/660/990 is described. In one configuration for an application processor deployment, instead of using the bi-directional capability, the first physical layer transceiver 550/580 is dedicated as a downlink physical transceiver and the second physical layer transceiver 560/590 re-uses the existing physical layer development.

In a further configuration, the first physical layer transmitter 650 of the modem 840 and the first physical layer receiver 580 of the application processor 810 are dedicated to the downlink and the second physical layer transceiver in both the modem 840 and the application processor 810 are specified as a downlink/uplink transceivers. In a further configuration, the physical layer transceivers of the modem 840 and the application processor (AP) 810 may be configured according to the following uplink (UL) and downlink (DL) transmit (Tx) and receive (Rx) lane configurations shown in Table 1 for meeting the category 5 (CAT5) peak data rate requirements.

TABLE 1
Dual Transceiver Lane Configurations

| | |
|---|---|
| Modem DL (Legacy) = 1 Tx lane | Modem UL (Legacy) = 1 Rx lane |
| Modem DL (CAT5) = 2 Tx lanes | Modem UL (CAT5) = 1 Rx lane |
| AP DL (Legacy) = 1 Rx lane | AP DL (CAT5) = 2 Rx lanes |
| AP UL (Legacy) = 1 Tx lane | AP UL (CAT5) = 1 Tx lane |

Although described with reference to a modem to application processor interface, the dual physical layer transceiver for high speed synchronous interface (HSI) frame interleaving may be integrated as part of various device to device interfaces including, but not limited to, modem to modem interfaces, WLAN (wireless local area network) to application processor interfaces, application processor to application processor interfaces, or the like.

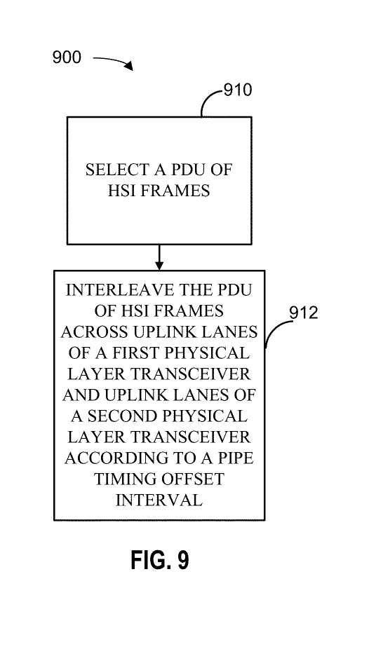

FIG. 9 is a block diagram illustrating a method 900 for high speed synchronous interface (HSI) frame interleaving, according to one aspect of the present disclosure. In block 910, a UE selects a protocol data unit (PDU) of high speed synchronous interface (HSI) frames. For example, the PDU of HSI frames is selected/provided from the transmit logical channel buffer 522 in response to the data/flag 552/562 signal, as shown in FIG. 5. In block 912, the UE interleaves the PDU of HSI frames across the uplink lanes of a first physical layer transceiver and the uplink lanes of a second physical layer transceiver according to a pipe offset interval. For example, the transmit frame interleaver 640 interleaves a PDU of HSI frames across the uplink lanes of the first physical layer transceiver 650/680 and the uplink lanes of a second physical layer transceiver 660/690 according to a pipe offset interval, as shown in FIGS. 6, 7A, and 7B. The inverse process is performed by the received frame de-interleaver 570/670 (FIGS. 5 and 6) in response to interleaved frames 750 to return the interleaved frames to an original order, as shown in FIGS. 7A and 7B.

In one configuration, the UE 120 is configured for wireless communication including means for selecting a protocol data unit (PDU) of high speed synchronous interface (HSI) frames, as shown in FIG. 4. In one aspect, the selection means may be the transmit logical channel buffer 522 configured to perform the functions recited by the selection means. The UE 120 is also configured to include a means for interleaving the PDU of HSI frames across the uplink lanes of a first physical layer transceiver and the uplink lanes of a second physical layer transceiver according to a pipe offset interval. In one aspect, this interleaver means may be the transmit frame interleaver 540/640 configured to perform the functions recited by the interleaver means. In another aspect, the aforementioned means may be a module or any apparatus configured to perform the functions recited by the aforementioned means.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
interleaving a protocol data unit (PDU) of high speed synchronous interface (HSI) frames across uplink lanes of a first physical layer transceiver and uplink lanes of a second physical layer transceiver according to a pipe timing offset.

2. The method of claim 1, in which interleaving further comprises:
transmitting a first HSI frame of the PDU over a transmit lane of the first physical layer transceiver; and then
transmitting, after a pipe offset interval, a second HSI frame of the PDU over a transmit lane of the second physical layer transceiver.

3. The method of claim 1, in which even numbered HSI frames of the PDU and odd numbered HSI frames of the PDU are separated according to the pipe offset.

4. The method of claim 1, in which interleaving further comprises:
frame striping the PDU of HSI frames across transmit lanes and at least one receive lane of the first physical layer transceiver and transmit lanes of the second physical layer transceiver according to the pipe timing offset.

5. The method of claim 1, further comprising:
receiving HSI frames on downlink lanes of the first physical layer transceiver and downlink lanes of the second physical layer transceiver; and
de-interleaving the received HSI frames according to the pipe offset.

6. The method of claim 1, in which the uplink lanes of the first physical layer transceiver comprise a plurality of transmit lanes and at least one receive lane of the first physical layer transceiver.

7. An apparatus configured for wireless communication, the apparatus comprising:
a memory; and
at least one processor coupled to the memory, the at least one processor being configured:
to interleave a protocol data unit (PDU) of high speed synchronous interface (HSI) frames across uplink lanes of a first physical layer transceiver and uplink lanes of a second physical layer transceiver according to a pipe offset.

8. The apparatus of claim 7, in which the processor is further configured to interleave by:
transmitting a first HSI frame of the PDU over a transmit lane of the first physical layer transceiver; and then
transmitting, after a pipe offset interval, a second HSI frame of the PDU over a transmit lane of the second physical layer transceiver.

9. The apparatus of claim 7, in which even numbered HSI frames of the PDU and odd numbered HSI frames of the PDU are separated according to the pipe offset.

10. The apparatus of claim 7, in which the processor is further configured to interleave by:
frame striping the PDU of HSI frames across transmit lanes and at least one receive lane of the first physical layer transceiver and transmit lanes of the second physical layer transceiver according to the pipe offset.

11. The apparatus of claim 7, in which the processor is further configured:
to receive HSI frames on downlink lanes of the first physical layer transceiver and downlink lanes of the second physical layer transceiver; and
to de-interleave the received HSI frames according to the pipe offset.

12. The apparatus of claim 7, in which the uplink lanes of the first physical layer transceiver comprise a plurality of transmit lanes and at least one receive lane of the first physical layer transceiver.

13. A computer program product configured for wireless communication, the computer program product comprising:
a non-transitory computer-readable medium having non-transitory program code recorded thereon, the program code comprising:
program code to interleave a protocol data unit (PDU) of high speed synchronous interface (HSI) frames across uplink lanes of a first physical layer transceiver and uplink lanes of a second physical layer transceiver according to a pipe offset.

14. An apparatus configured for operation within a wireless communication network, the apparatus comprising:
means for receiving a protocol data unit (PDU) of high speed synchronous interface (HSI) frames; and
means for interleaving the PDU of HSI frames across uplink lanes of a first physical layer transceiver and uplink lanes of a second physical layer transceiver according to a pipe offset.

15. An apparatus for wireless communication, comprising:
a first physical layer transceiver;
a second physical layer transceiver; and
a frame interleaver operable to interleave a protocol data unit (PDU) of high speed synchronous interface (HSI) frames across uplink lanes of the first physical layer transceiver and uplink lanes of the second physical layer transceiver according to a pipe offset.

16. The apparatus of claim 15, in which the first physical layer transceiver comprises a plurality of transmit lanes and receive lanes, and the uplink lanes of the first physical layer transceiver comprise the plurality of the transmit lanes and at least one of the receive lanes of the first physical layer transceiver.

17. The apparatus of claim 15, further comprising:
a frame de-interleaver operable to receive HSI frames on downlink lanes of the first physical layer transceiver and downlink lanes of the second physical layer transceiver and to de-interleave the received HSI frames according to the pipe offset; and
a receive logical buffer operable to store the de-interleaved HSI frames.

18. The apparatus of claim 15, further comprising a transmit logical channel buffer operable to store HSI data frames for uplink transmission.

19. An apparatus for wireless communication, comprising:
a first physical layer transceiver;
a second physical layer transceiver; and
means for interleaving a protocol data unit (PDU) of high speed synchronous interface (HSI) frames across uplink lanes of the first physical layer transceiver and uplink lanes of the second physical layer transceiver according to a pipe offset.

20. The apparatus of claim 19, further comprising:
means for frame striping the PDU of HSI frames across transmit lanes and at least one receive lane of the first physical layer transceiver and transmit lanes of the second physical layer transceiver according to the pipe offset.
